(19) United States
(12) Patent Application Publication
(10) Pub. No.: US 2021/0284441 A1
(43) Pub. Date: Sep. 16, 2021

(54) DUAL COMPARTMENT WASTEBASKETS

(71) Applicant: Decolin Inc., Montreal (CA)

(72) Inventors: Ned Jones, Simi Valley, CA (US); David M. Baines, Bedford, NY (US)

(21) Appl. No.: 17/202,940

(22) Filed: Mar. 16, 2021

Related U.S. Application Data
(60) Provisional application No. 62/990,197, filed on Mar. 16, 2020.

(51) Int. Cl. B65F 1/00; B65F 1/02

(52) U.S. Cl. CPC B65F 1/0053; B65F 2210/138; B65F 2001/0086; B65F 1/02

(57) ABSTRACT

Dual compartment wastebaskets with two detachable containers are disclosed, one of which may be marked for recycling. The detachable containers may be connected together with clips, magnets and the like, allowing for easy separation to empty them. In certain embodiments, mechanical alignment means, such as opposing channels, steps or frames, may be used.

### CROSS-REFERENCE TO RELATED APPLICATION

This application claims the benefit of U.S. Provisional Patent Application No. 62/990,197 filed Mar. 16, 2020, which is incorporated herein by reference.

### FIELD OF THE INVENTION

The present invention relates to dual compartment wastebaskets.

### BACKGROUND INFORMATION

Many households and communities recycle paper, metal, glass and the like separately from regular trash. However, within homes, hotel rooms and other residential and commercial settings, this has usually been done using separate containers in some rooms and a single container in other rooms. A single basket with a divider has occasionally been used, but such a single basket is quite difficult to empty.

### SUMMARY OF THE INVENTION

The present invention provides dual compartment wastebaskets with two detachable containers, one of which may be marked for recycling. The detachable containers may be connected together with clips, magnets and the like, allowing for easy separation to empty them. In certain embodiments, mechanical alignment means, such as opposing channels, steps or frames, may be used. While the dual compartment wastebaskets may typically be smaller and more discreet than two regular wastebaskets, the present wastebaskets can be of any desired size or shape.

An aspect of the present invention is to provide a dual compartment wastebasket comprising: a first basket including a first base, a first interior engaging wall, a first upper alignment edge, and a first exterior sidewall; a second basket releasingly engageable with the first basket including a second base, a second interior engaging wall, a second upper alignment edge, and a second exterior sidewall, wherein the first and second interior engaging walls are at least partially coextensive and contact each other when the first and second baskets are attached to each other, and the first and second interior engaging walls are separated from each other when the first and second baskets are detached from each other; and a securement member structured and arranged to releasingly hold the first and second baskets together when the first and second interior engaging walls are in contact with each other.

This and other aspects of the present invention will be more apparent from the following description.

### BRIEF DESCRIPTION OF THE DRAWINGS

FIG. 1 is an isometric view of a dual compartment wastebasket of the present invention.

FIG. 2 is an isometric view of a first part of the dual compartment wastebasket shown in FIG. 1 intended for disposal of conventional waste.

FIG. 3 is a front view and FIG. 4 is a side view of the first wastebasket of FIG. 2.

FIG. 5 is a sectional view taken through line 5-5 of FIG. 4.

FIG. 6 is a top view of the first wastebasket of FIG. 2.

FIG. 7 is an isometric view and FIG. 8 is a side view of an attachment clip for the dual compartment wastebasket of FIGS. 1-6.

FIG. 9 is an isometric view and FIG. 10 is a top view of a dual compartment wastebasket in accordance with another embodiment of the present invention.

FIG. 11 is an isometric view of the dual compartment wastebasket of FIGS. 9 and 10.

FIG. 12 is an isometric view of a first wastebasket detached a second recyclable basket (not shown) of FIG. 11.

FIG. 13 is an isometric view and FIG. 14 is a top view of another dual compartment wastebasket of the present invention.

FIG. 15 is an isometric view of the dual compartment wastebasket of FIGS. 13 and 14.

FIG. 16 is an isometric view of a first wastebasket separated from a second recyclable basket (not shown) of FIG. 15.

FIG. 17 is an isometric view of another dual compartment wastebasket of the present invention.

FIG. 18 is a side view of the dual compartment wastebasket of FIG. 17 with first and second baskets separated from each other.

### DETAILED DESCRIPTION

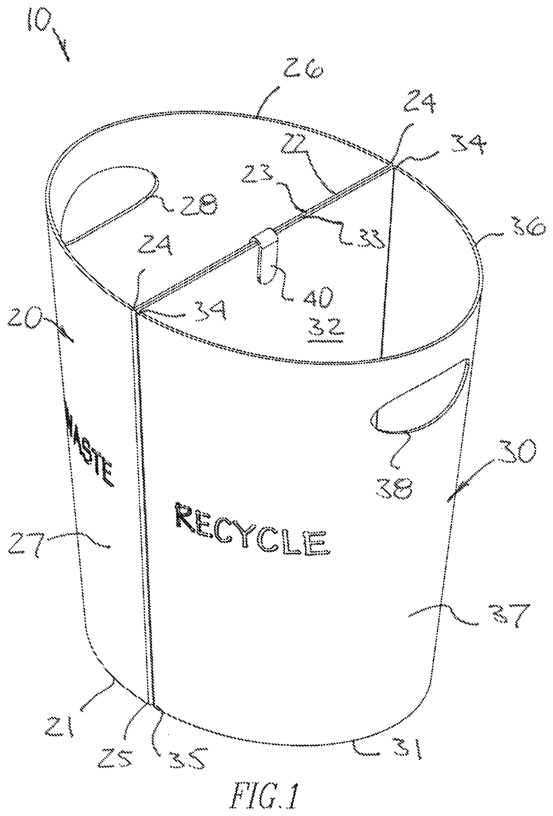

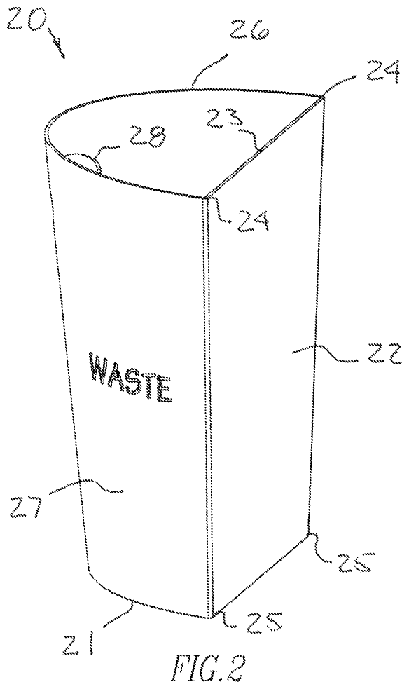

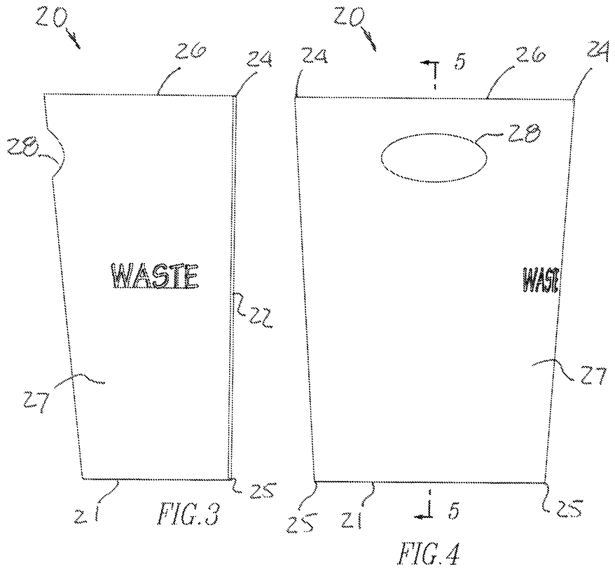

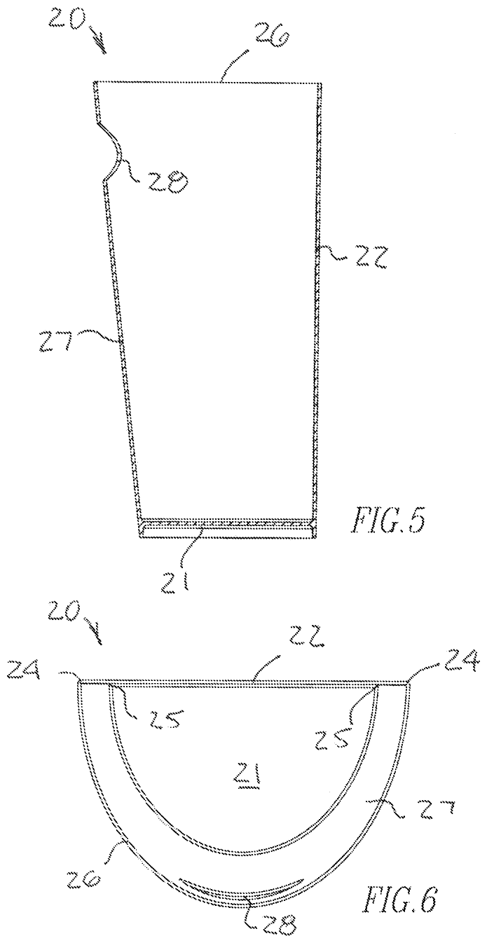

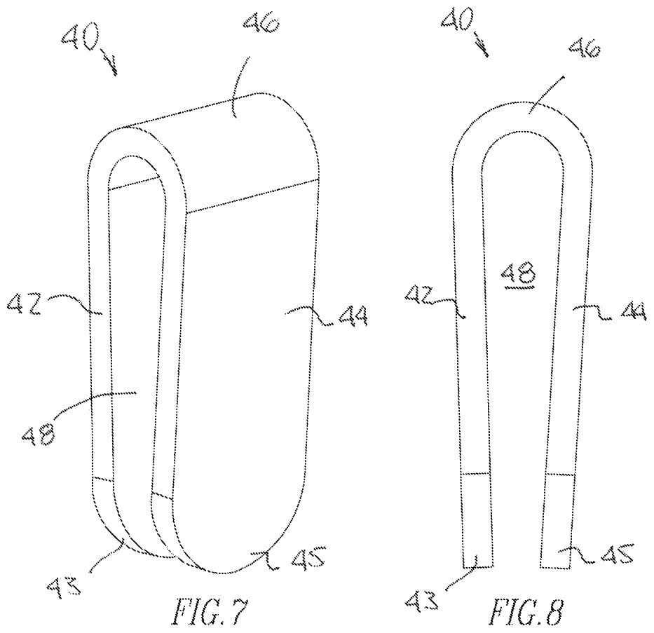

FIGS. 1-8 illustrate a dual compartment wastebasket 10 in accordance with an embodiment of the present invention. The dual compartment wastebasket 10 includes a first releasingly engageable basket 20, which may be used for conventional trash. The first basket 20 includes a first base 21 and a first interior engaging wall 22, which is substantially planar in the embodiment shown. A first upper alignment edge 23 is provided along the top of the first engaging wall 22. First upper side corners 24 are located at the ends of the first upper alignment edge 23, and first lower side corners 25 are provided at the intersection of the first base 21 and first engaging wall 22. The first basket 20 includes a first upper peripheral edge 26 that intersects the first upper alignment edge 23. The first basket 20 includes a first exterior sidewall 27 with a first handle opening 28 extending therethrough.

As further shown in FIGS. 1-8, the dual compartment wastebasket 10 includes a second releasingly engageable basket 30, which may be used for recyclables. The second basket 30 includes a second base 31 and a second interior engaging wall 32, which is substantially planar in the embodiment shown. The second engaging wall 32 terminates in a second upper alignment edge 33. Second upper side corners 34 are located at the ends of the second upper alignment edge 33, and second lower side corners 35 are provided at the intersection of the second base 31 and second engaging wall 32. The second basket 30 includes a second upper peripheral edge 36 that intersects the second upper alignment edge 33. Second basket 30 includes a second exterior sidewall 37 having a second handle opening 38 therethrough. When the first and second baskets 20 and 30 are assembled together, the first and second interior engaging walls 22 and 32 are coextensive with each other, and their upper and lower side corners 24, 34 and 25, 35 align with each other. The first and second interior engaging walls 22 and 32 may be planar as shown, or may be other shapes such as curved, e.g., convex, concave or a combination thereof.

The first and second engageable baskets 20 and 30 may be made of any suitable materials including metals such as stainless steel, wood, bamboo, medium density fiberboard, resin and polymers such as polypropylene (PP) and the like.

As shown most clearly in FIGS. 1, 7 and 8, a releasable attachment clip 40 is used to secure the first and second engaging walls 22 and 32 together during normal use of the dual compartment wastebasket 10. The attachment clip 40 includes a first clip arm 42 with a first clip lower tip 43, and a second clip arm 44 with a second clip lower tip 45. A generally U-shaped connector 46 is integrally formed with the first and second clip arms 42 and 44. The U-shaped connector 46, first clip arm 42 and second clip arm 44 form a receiving channel 48 for the first and second engaging walls 22 and 32 of the dual compartment wastebasket 10. Although a generally U-shaped connector 46 is shown, any other suitable clip or clamping mechanism may be used, and any suitable number of such clips or clamps may be provided, e.g., one, two, three or the like. For example, two clips may be provided at the approximate locations of the magnets. The attachment clip 40 may be made of any suitable material including polymers such as polypropylene (PP), acrylonitrile butadiene styrene (ABS), high impact polystyrene (HIPS), polyamide (Nylon) and the like, and metals such as stainless steel and the like.

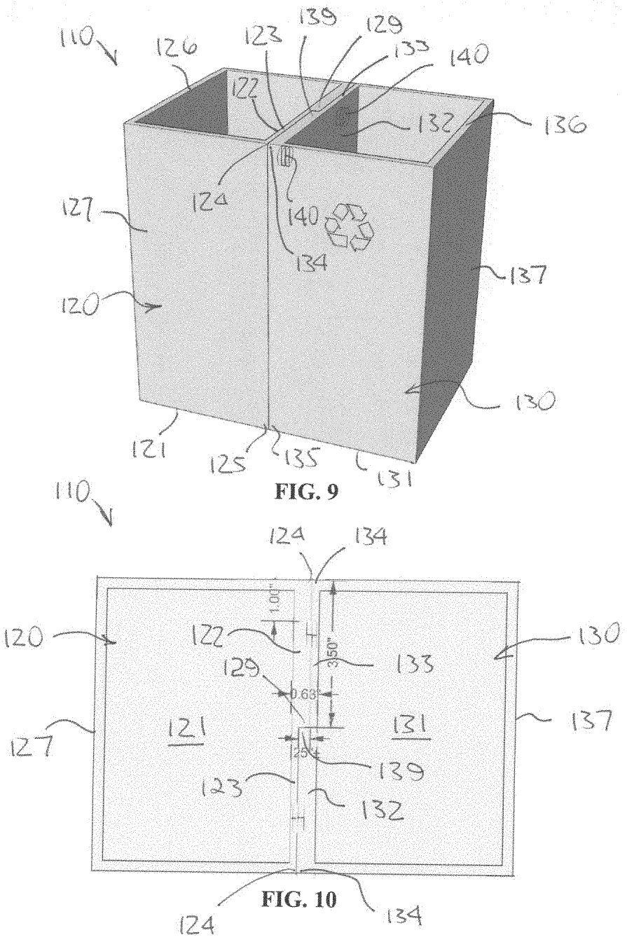

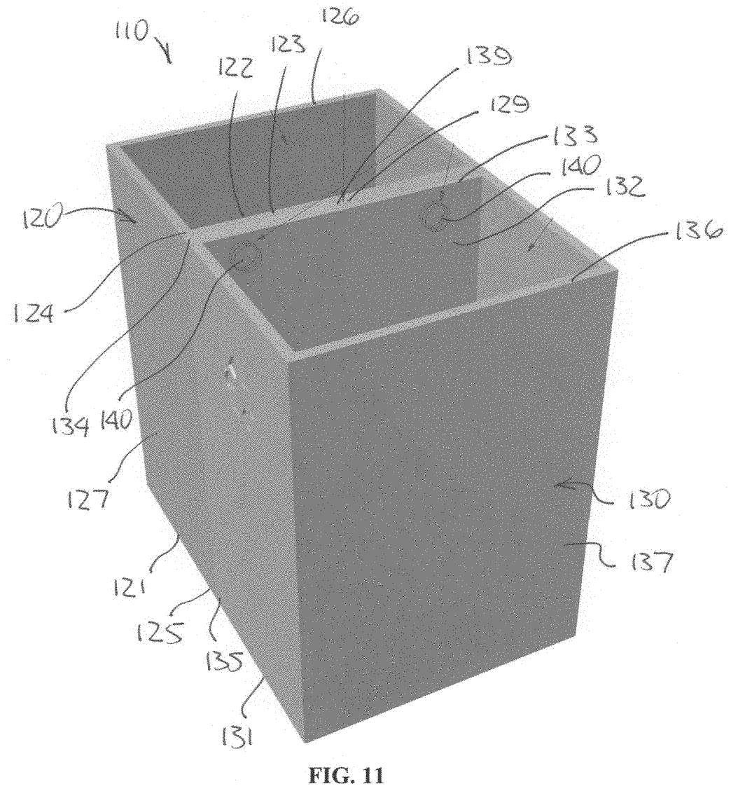

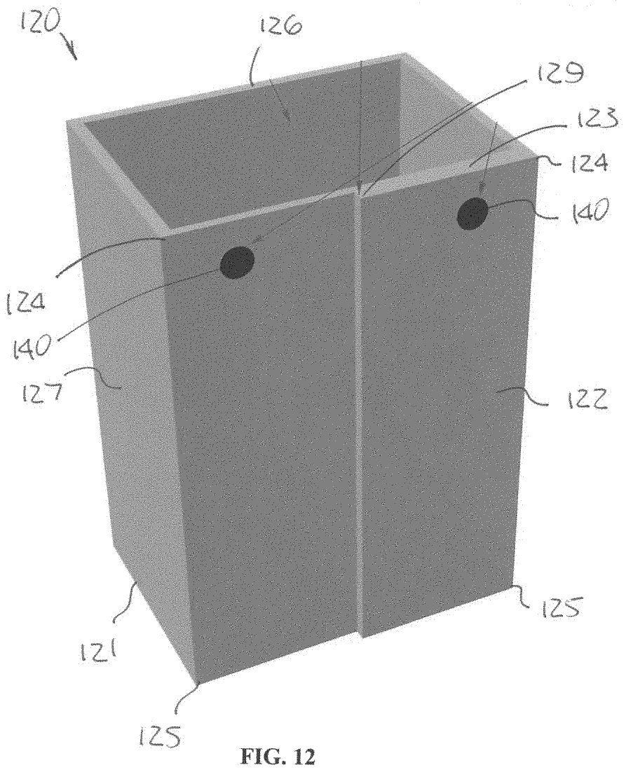

FIGS. 9-12 illustrate a dual compartment wastebasket 110 with first and second releasingly engageable baskets 120 and 130 in accordance with another embodiment of the present invention. The first basket 120 includes a first base 121 and a first interior engaging wall 122 that is substantially planar. A first upper alignment edge 123 is provided along the top of the first engaging wall 122. First upper side corners 124 are located at the ends of the first upper alignment edge 123, and first lower side corners 125 are provided at the intersection of the first base 121 and first engaging wall 122. The first basket 120 includes a first upper peripheral edge 126 that intersects the first upper alignment edge 123. The first basket 120 includes a first exterior sidewall 127. A first vertical alignment step 129 is provided in the first interior engaging wall 122.

The second basket 130 includes a second base 131 and a second interior engaging wall 132 that is substantially planar. The second engaging wall 132 terminates in a second upper alignment edge 133. Second upper side corners 134 are located at the ends of the second upper alignment edge 133, and second lower side corners 135 are provided at the intersection of the second base 131 and second engaging wall 132. The second basket 130 includes a second upper peripheral edge 136 that intersects the second upper alignment edge 133. Second basket 130 includes a second exterior sidewall 137. A second vertical alignment step 139 is provided in the second interior engaging wall 132.

In the embodiment shown, two sets of recessed attachment magnets 140 are provided near the top edges 123 and 133 of the opposing sidewalls 122 and 132 of the rectangular basket halves 120 and 130. In addition to the attachment magnets 140, the first and second alignment steps 129 and 139 help align the basket halves 120 and 130 when assembled together.

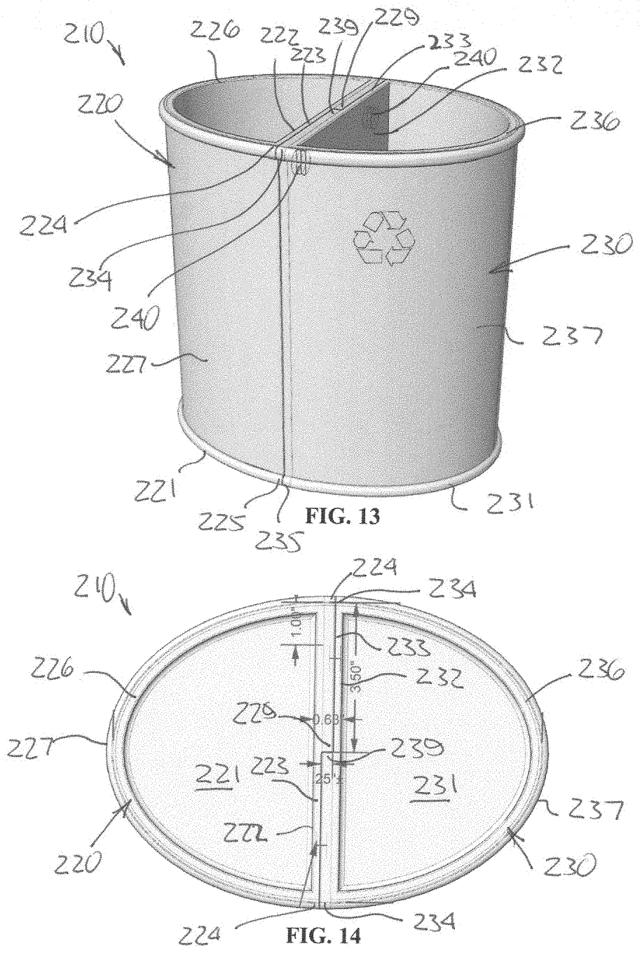

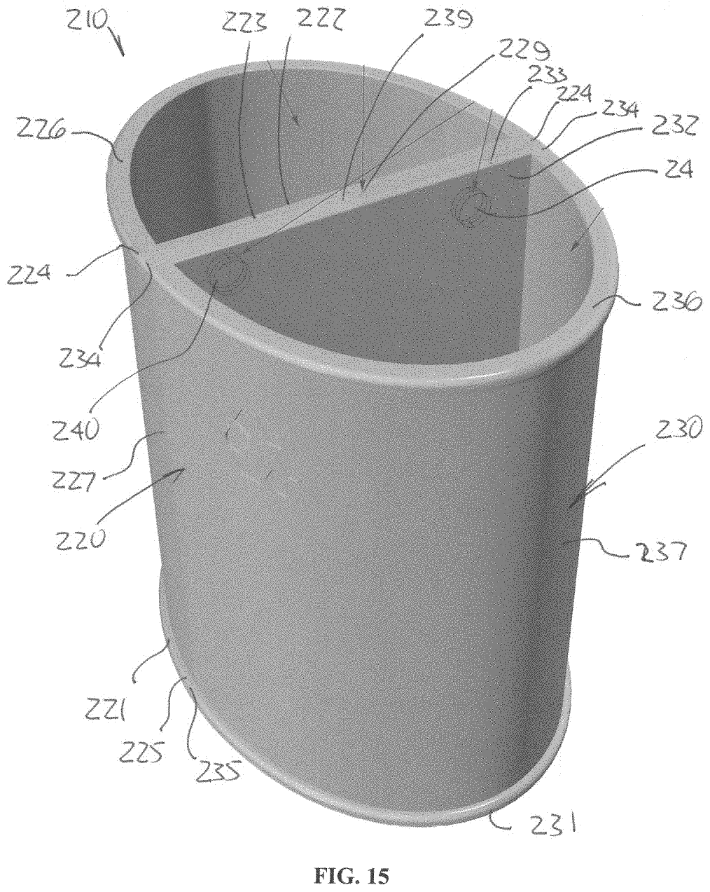

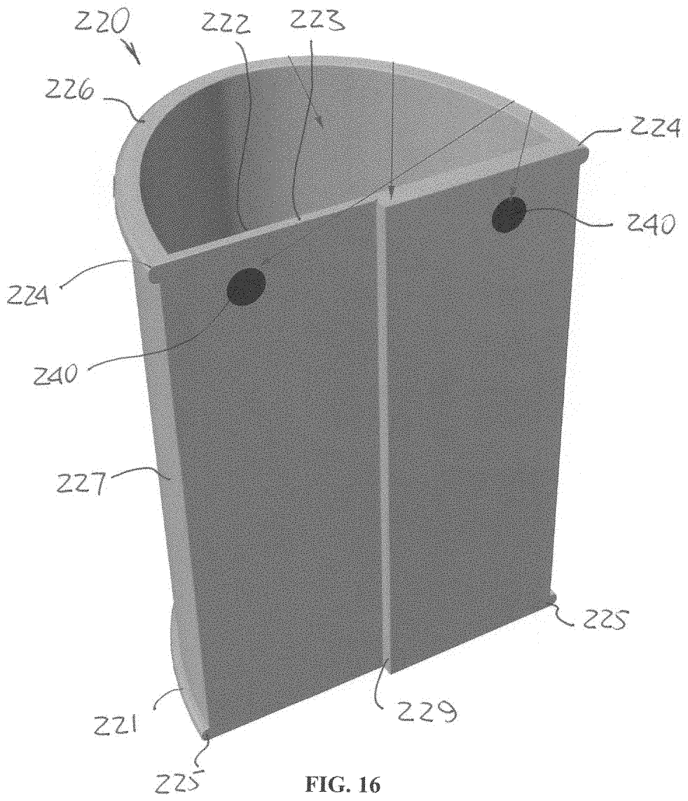

FIGS. 13-16 illustrate and describe a dual compartment wastebasket 210 with first and second releasingly engageable baskets 220 and 230 in accordance with a further embodiment of the present invention. The first basket 220 includes a first base 221 and a first interior engaging wall 222 that is substantially planar. A first upper alignment edge 223 is provided along the top of the first engaging wall 222. First upper side corners 224 are located at the ends of the first upper alignment edge 223, and first lower side corners 225 are provided at the intersection of the first base 221 and first engaging wall 222. The first basket 220 includes a first upper peripheral edge 226 that intersects the first upper alignment edge 223. The first basket 220 includes a first exterior sidewall 227. A first vertical alignment step 229 is provided in the first interior engaging wall 222.

The second basket 230 includes a second base 231 and a second interior engaging wall 232 that is substantially planar. The second engaging wall 232 terminates in a second upper alignment edge 233. Second upper side corners 234 are located at the ends of the second upper alignment edge 233, and second lower side corners 235 are provided at the intersection of the second base 231 and second engaging wall 232. The second basket 230 includes a second upper peripheral edge 236 that intersects the second upper alignment edge 233. Second basket 230 includes a second exterior sidewall 237. A second vertical alignment step 239 is provided in the second interior engaging wall 232.

In the embodiment shown, two sets of recessed attachment magnets 240 are provided near the top edges 223 and 233 of the opposing sidewalls 222 and 232 of the semi-circular basket halves 220 and 230. In addition to the attachment magnets 240, the first and second alignment steps 229 and 239 help align the basket halves 220 and 230 when assembled together.

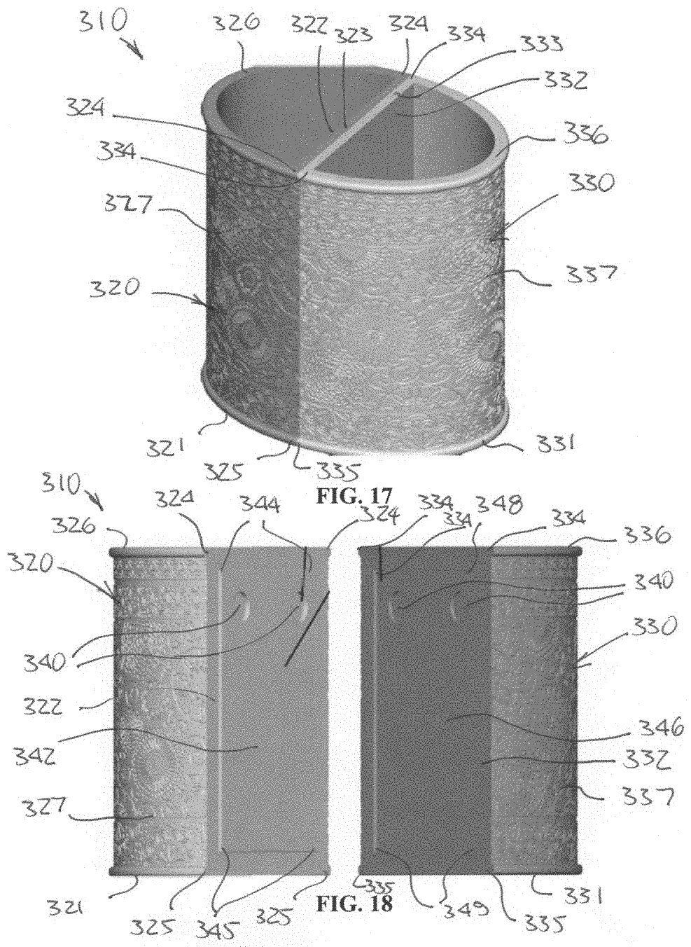

FIGS. 17 and 18 illustrate a dual compartment wastebasket 310 with first and second releasingly engageable baskets 320 and 330 similar to the embodiment shown in FIGS. 13-16, except the vertical alignment step has been replaced with an opposing rectangular alignment configuration including a rectangular raised panel 342 on the exterior surface of the first engaging wall 322, and an opposing rectangular or recessed tray 346 in the exterior surface of the second engaging wall 332. The raised panel 342 includes upper raised corners 344 and lower raised corners 345. The recessed tray 346 includes upper recessed corners 348 and lower recessed corners 349.

In the embodiment shown in FIGS. 17 and 18, the first basket 320 includes a first base 321 and a first interior engaging wall 322 that is substantially planar. A first upper alignment edge 323 is provided along the top of the first engaging wall 322. First upper side corners 324 are located at the ends of the first upper alignment edge 323, and first lower side corners 325 are provided at the intersection of the first base 321 and first engaging wall 322. The first basket 320 includes a first upper peripheral edge 326 that intersects the first upper alignment edge 323. The first basket 320 includes a first exterior sidewall 327.

The second basket 330 includes a second base 331 and a second interior engaging wall 332 that is substantially planar. The second engaging wall 332 terminates in a second upper alignment edge 333. Second upper side corners 334 are located at the ends of the second upper alignment edge 333, and second lower side corners 335 are provided at the intersection of the second base 331 and second engaging wall 332. The second basket 330 includes a second upper peripheral edge 336 that intersects the second upper alignment edge 333. Second basket 330 includes a second exterior sidewall 337.

Two sets of recessed attachment magnets 340 are provided near the top edges 323 and 333. In addition to the attachment magnets 340, the raised panel 342 fits inside the recessed tray 346 to align the first and second baskets 320 and 330.

Although two sets of opposing magnets are shown in the embodiments described above, any other suitable number may be used. Furthermore, the alignment features such as channels and recesses shown in the figures may comprise any other suitable configurations, shapes, sizes, numbers and locations, or may optionally be eliminated.

As used herein. “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A dual compartment wastebasket comprising:
a first basket including a first base, a first interior engaging wall, a first upper alignment edge, and a first exterior sidewall;
a second basket releasingly engageable with the first basket including a second base, a second interior engaging wall, a second upper alignment edge, and a second exterior sidewall, wherein the first and second interior engaging walls are at least partially coextensive and contact each other when the first and second baskets are attached to each other, and the first and second interior engaging walls are separated from each other when the first and second baskets are detached from each other; and
a securement member structured and arranged to releasingly hold the first and second baskets together when the first and second interior engaging walls are in contact with each other.

2. The dual compartment wastebasket of claim 1, wherein the first and second interior engaging walls are planar.

3. The dual compartment wastebasket of claim 2, wherein the first and second upper alignment edges are adjacent to each other and parallel with each other when the first and second baskets are attached to each other.

4. The dual compartment wastebasket of claim 3, wherein the first interior engaging wall has two first upper side corners and two first lower side corners, and the second interior engaging wall has two second upper side corners and two second lower side corners that align with respective ones of first upper and first lower side corners when the first and second baskets are attached to each other.

5. The dual compartment wastebasket of claim 3, wherein the securement member comprises at least one attachment clip releasingly attached over the first and second upper alignment edges and contacting the first and second interior engaging walls.

6. The dual compartment wastebasket of claim 5, wherein the attachment clip comprises a first clip arm structured and arranged to contact the first interior engaging wall, a second clip arm structured and arranged to contact the second interior engaging wall, and a U-shaped connector extending between the first and second clip arms.

7. The dual compartment wastebasket of claim 6, wherein the first and second clip arms and the U-shaped connector are integrally formed.

8. The dual compartment wastebasket of claim 1, wherein the first and second interior engaging walls are planar and completely coextensive with each other.

9. The dual compartment wastebasket of claim 8, wherein the first and second exterior sidewalls are curved and form a cross-sectional shape that is circular, ovular or elliptical.

10. The dual compartment wastebasket of claim 1, wherein the first exterior sidewall has a first handle opening extending therethrough, and the second exterior sidewall has a second handle opening extending therethrough.

11. The dual compartment wastebasket of claim 1, wherein the securement member comprises at least one magnet attached to the first or second interior engaging walls.

12. The dual compartment wastebasket of claim 11, comprising a first magnet attached to the first interior engaging wall and an opposing second magnet attached to the second interior engaging wall.

13. The dual compartment wastebasket of claim 12, comprising at least two of the first magnets and at least two of the opposing second magnets.

14. The dual compartment wastebasket of claim 1, further comprising an alignment feature on at least one of the first and second interior engaging walls structured and arranged to hold the first and second baskets in aligned positions when the first and second interior engaging walls contact each other.

15. The dual compartment wastebasket of claim 14, wherein the alignment feature comprises a first vertical step in the first interior engaging wall that contacts a second vertical step in the second interior engaging wall.

16. The dual compartment wastebasket of claim 14, wherein the alignment feature comprises a raised panel on one of the first and second interior engaging walls that fits inside a recessed tray in the other one of the first and second interior engaging walls.

17. The dual compartment wastebasket of claim 16, wherein the raised panel and the recessed tray are rectangular.
